(19) United States
(12) Patent Application Publication
(10) Pub. No.: US 2024/0343411 A1
(43) Pub. Date: Oct. 17, 2024

(54) AIRCRAFT WIRE HARNESS

(71) Applicant: HarcoSemco LLC, Branford, CT (US)

(72) Inventors: Thomas Bieluch, Stamford, CT (US); John Dutra, Guilford, CT (US)

(73) Assignee: HarcoSemco LLC, Branford, CT (US)

(21) Appl. No.: 18/635,443

(22) Filed: Apr. 15, 2024

Related U.S. Application Data
(60) Provisional application No. 63/496,154, filed on Apr. 14, 2023.
(60) Provisional application No. 63/566,988, filed on Mar. 19, 2024.

(51) Int. Cl. B64D 47/00; H02G 3/32

(52) U.S. Cl. CPC B64D 47/00; H02G 3/32

(57) ABSTRACT

Provided is a thermocouple wire harness including a first branch, a second branch extending about ninety degrees from the first branch in a first direction and having a first pair of thermocouple terminal breakouts extending therefrom for coupling to a first thermocouple, and a third branch extending about ninety degrees from the first branch in a second direction opposite the first direction, the third branch having a second pair of thermocouple terminal breakouts extending therefrom for coupling to a second thermocouple, a third pair of thermocouple terminal breakouts extending therefrom for coupling to a third thermocouple, and a fourth pair of thermocouple terminal breakouts extending therefrom for coupling to a fourth thermocouple.

### RELATED APPLICATIONS

This application claims the benefit of U.S. Provisional Application No. 63/496,154 filed Apr. 14, 2023 and U.S. Provisional Application No. 63/566,988 filed Mar. 19, 2024, which are hereby incorporated herein by reference.

### FIELD OF INVENTION

The present invention relates generally to a wire harness, and more particularly to a wire harness for an aircraft.

### BACKGROUND

Modern aircraft that are operating at high speeds are known to be subjected to great stress, strain and shock. Accordingly, a thermocouple apparatus in the aircraft must not only be adapted to elevated states and rapid changes of temperature, but it must also be characterized by robust design and construction to reliably operate at these severe environmental conditions. Additionally, the thermocouples have to be located at points spaced about the periphery of the gas turbine tail cone or pipe in order to obtain meaningful temperature measurements. Furthermore, the thermocouples are mounted about the tail cone or pipe of the gas turbine in such a way that the failure of any one or more of the thermocouples does not affect or nullify the functioning of any other of the thermocouples, and so that their total or average indication is utilized as the significant value or measurement of gas stream temperature.

### SUMMARY

According to an aspect, a thermocouple wire harness includes a first branch, a second branch extending about ninety degrees from the first branch in a first direction and having a first pair of thermocouple terminal breakouts extending therefrom for coupling to a first thermocouple, and a third branch extending about ninety degrees from the first branch in a second direction opposite the first direction, the third branch having a second pair of thermocouple terminal breakouts extending therefrom for coupling to a second thermocouple, a third pair of thermocouple terminal breakouts extending therefrom for coupling to a third thermocouple, and a fourth pair of thermocouple terminal breakouts extending therefrom for coupling to a fourth thermocouple.

The third pair of thermocouple terminal breakouts is closer to the second pair of thermocouple terminal breakouts than to the fourth pair of thermocouple terminal breakouts.

The thermocouple wire harness may additionally include an anti-rotation clip for coupling the first branch to a watershield of an engine, wherein the anti-rotation clip includes a tab configured to contact a surface of the watershield to prevent full rotation of the thermocouple wire harness.

The anti-rotation clip includes a first leg including an opening for coupling to the watershield, and a second leg including the tab.

The thermocouple wire harness may additionally include another anti-rotation clip for coupling the first branch to the watershield, wherein the another anti-rotation clip includes a tab configured to contact the surface of the watershield to prevent full rotation of the thermocouple wire harness.

The another anti-rotation clip includes a first leg including an opening for coupling to the watershield, and a second leg including the tab.

The second leg on the another anti-rotation clip is longer than the second leg on the anti-rotation clip.

One of the wires in each pair is of a first material having a first resistivity and one of the wires in each pair is of a second material having a second resistivity different than the first resistivity.

The second branch includes a fifth pair of thermocouple terminal breakouts extending therefrom for coupling to a fifth thermocouple, and wherein the third branch has a sixth pair of thermocouple terminal breakouts extending therefrom for coupling to a sixth thermocouple, a seventh pair of thermocouple terminal breakouts extending therefrom for coupling to a seventh thermocouple, and an eighth pair of thermocouple terminal breakouts extending therefrom for coupling to an eighth thermocouple.

The third branch is at least six times longer than the second branch.

According to another aspect, a thermocouple wire harness includes a plurality of wires of a first material having a first resistivity, each of the plurality of wires being coupled to at least one of a first plurality of wire splices, and at least two of the wires being coupled to a respective thermocouple, and a plurality of wires of a second material having a second resistivity different than the first resistivity, each of the plurality of wires of the second material being coupled to at least one of a second plurality of wire splices, and at least two of the wires being coupled to a respective one of the thermocouples;

One of the plurality of wires of the first material extends from a connector to one of the first plurality of wire splices and is a first length, and one of the plurality of wires of the second material extends from the connector to one of the second plurality of wire splices and is a second length greater than the first length.

The second length is at least one and a half times greater than the first length.

A total wire length of the plurality of wires of the second material is greater than a total wire length of the plurality of wires of the first material.

According to still another aspect, a thermocouple wire harness includes a first wire of a first material having a first resistivity coupled to a first wire splice, a second wire of the first material coupled to the first wire splice and a first thermocouple, a third wire coupled to the first wire splice and a second wire splice, a fourth wire coupled to the second wire splice and a second thermocouple, a fifth wire coupled to the second wire splice and a third wire splice, a sixth wire coupled to the third wire splice and a third thermocouple, and a seventh wire coupled to the third wire splice and a fourth thermocouple.

The first wire has a length greater than the seventh wire, which has a length greater than the fifth wire, which has a length greater than the third wire, which has a length greater than the second, fourth, and sixth wires.

The thermocouple wire harness further includes a first wire of a second material having a second resistivity different than the first material coupled to a first wire splice, a second wire of the second material coupled to the first wire spice and the fourth thermocouple, a third wire of the second material coupled to the first wire spice and a second wire splice, a fourth wire of the second material coupled to the second wire splice and the third thermocouple, a fifth wire of the second material coupled to the second wire splice and a third wire splice, a sixth wire of the second material coupled to the third wire splice and the second thermocouple, and a seventh wire of the second material coupled to the third wire splice and the first thermocouple.

The first wire has a length greater than the second wire, which has a length greater than the third wire, which has a length greater than the fourth wire, which has a length greater than the seventh wire, which has a length greater than the sixth wire, which has a length greater than the fifth wire.

The first wire has a length greater than the third wire, which has a length greater than the second wire, which has a length greater than the fourth wire, which has a length greater than the seventh wire, which has a length greater than the sixth wire, which has a length greater than the fifth wire.

A total length of the first, second, third, fourth, fifth, sixth, and seventh wires of the second material is greater than a total length of the first, second, third, fourth, fifth, sixth, and seventh wires of the first material.

According to yet another aspect, a method of routing a wire harness around an engine is provided, the wire harness including a first branch extending along the engine and second and third branches extending circumferentially around the engine, the method including coupling the first branch to the engine, coupling the second branch to a P-flange of the engine via at least one clip, and coupling the third branch to the P-flange via a plurality of clips, wherein the second and third branches are positioned between thermocouple probe assemblies and the P-flange.

The method includes coupling the second branch to a T-flange of the engine via a clip in a single location.

According to a further aspect, a thermocouple probe assembly includes a body having a plurality of openings for receiving respective studs, first and second wings extending from opposite sides of the body, each wing having an opening for receiving a fastener for securing the assembly to an engine, wherein each side of the body has a first portion spaced a first distance from the first portion of the opposite side, a second portion angled outward form the respective first portion, and a third portion spaced a second distance from the second portion of the opposite side, and wherein the second distance is greater than the first distance.

### BRIEF DESCRIPTION OF THE DRAWINGS

FIG. 1 is a perspective view of an exemplary wire harness.

FIGS. 1A-1C are detail views of areas A, B, and C in FIG. 1.

FIG. 2 is a schematic wire diagram.

FIG. 3 is another schematic wire diagram.

FIG. 4 is a front perspective view of an exemplary thermocouple probe assembly.

FIG. 5 is a rear perspective view of the thermocouple probe assembly.

FIG. 6 is a top view of the thermocouple probe assembly.

FIG. 7 is a left side view of the thermocouple probe assembly.

FIG. 8 is a perspective view of the thermocouple probe assembly and a tool on-bolt.

FIG. 9 is a top view of the thermocouple probe assembly and the tool.

FIG. 10 is a perspective view of the thermocouple probe assembly and another tool on-bolt.

FIG. 11 is a top view of the thermocouple probe assembly and the tool.

FIG. 12 is a perspective view of the thermocouple probe assembly and still another tool on-bolt.

FIG. 13 is a top view of the thermocouple probe assembly and the tool.

FIG. 14 is a perspective view of an exemplary anti-rotation clip.

FIG. 15 is a front view of the anti-rotation clip.

FIG. 16 is a rear view of the anti-rotation clip.

FIG. 17 is a left side view of the anti-rotation clip.

FIG. 18 is a right side view of the anti-rotation clip.

FIG. 19 is a top view of the anti-rotation clip.

FIG. 20 is a bottom view of the anti-rotation clip.

FIG. 21 is a perspective view of another exemplary anti-rotation clip.

FIG. 22 is a front view of the anti-rotation clip.

FIG. 23 is a rear view of the anti-rotation clip.

FIG. 24 is a left side view of the anti-rotation clip.

FIG. 25 is a right side view of the anti-rotation clip.

FIG. 26 is a top view of the anti-rotation clip.

FIG. 27 is a bottom view of the anti-rotation clip.

FIG. 28 is a perspective view of an aircraft engine with the wire harness installed.

FIG. 29 is another perspective view of the aircraft engine with the wire harness installed.

FIG. 30 is still another perspective view of the aircraft engine with the wire harness installed.

FIG. 31 is yet another perspective view of the aircraft engine with the wire harness installed.

FIG. 32 is a further perspective view of the aircraft engine with the wire harness installed.

FIG. 33 is another perspective view of the aircraft engine with the wire harness installed.

### DETAILED DESCRIPTION

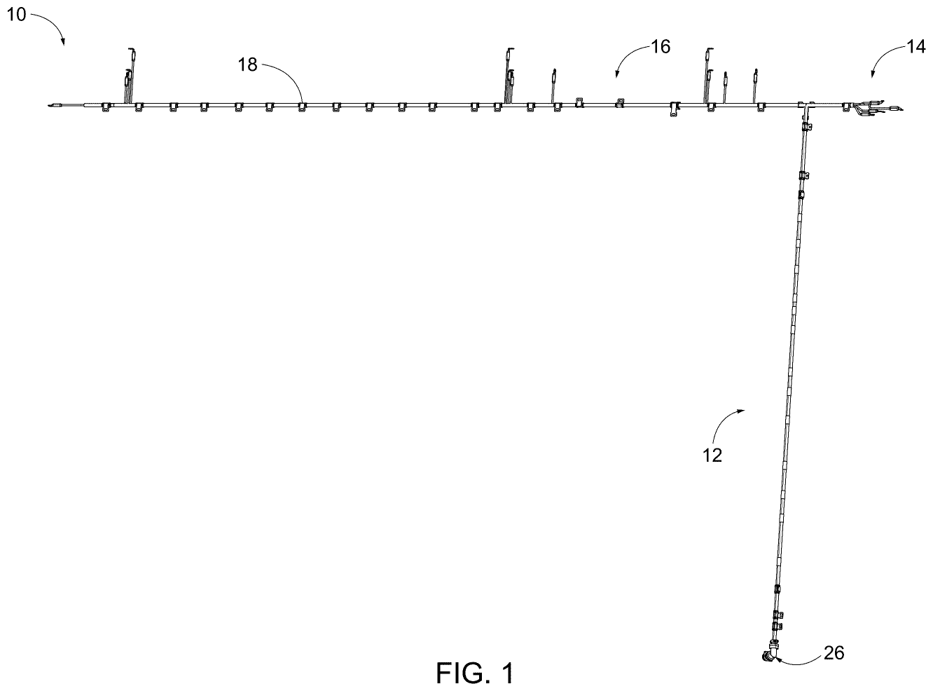

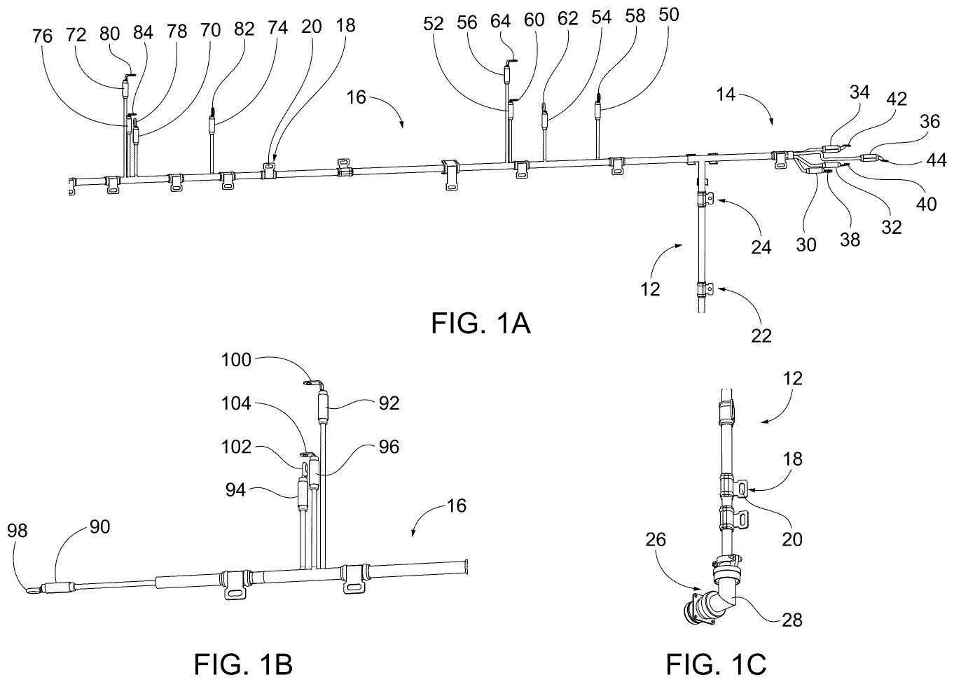

Turning initially to FIG. 1, a wire harness, such as a thermocouple wire harness for an aircraft is shown generally at reference numeral 10. The wire harness 10 is designed to be installed around a turbine engine of an aircraft to obtain temperature measurements from the engine. The harness 10 includes a first branch 12, a second branch 14, and a third branch 16. The harness 10 is substantially T-shaped, with the first branch 12 forming the vertical of the T, the second branch 14 forming part of the horizontal of the T, and the third branch 16 forming part of the horizontal of the T with the third branch 16 being longer than the second branch 14, for example at least four times longer, and in an implementation, at least six times longer.

Spaced along the length of the first, second, and third branches 12-16 are clips 18 that each include an opening 20 for receiving a fastener to couple the harness to the engine of the aircraft. The first branch 12 can also include a pair of anti-rotate clips 22 and 24 at the end of the branch 12 near the intersection with the second and third branches 14 and 16, which will be described below in detail, and a connector 26 at the opposite end for coupling to another harness or an engine control. The connector 26 includes a backshell 28, such as a ninety-degree backshell that includes stuffing, such as ceramic fiber stuffing to reduce or eliminate wire chafing.

The second branch 14 has extending from it one or more thermocouple terminal breakouts, and as show, four thermocouple terminal breakouts 30, 32, 34 and 36 each having a wire end crimp terminal 38, 40, 42, 44 configured to couple to a thermocouple probe assembly, sometimes referred to as TC2, as described in detail below. Two of the breakouts 30 and 32 are for a first or A circuit, and two of the breakouts 34 and 36 are for a second or B circuit. Each of the first and second circuits includes a wire of a first material having a first resistivity and a wire of a second material having a second resistivity different than the first resistivity. For example, each of the first and second circuits can include a wire of the first material having the first resistivity such as an Alumel (NiAl) wire and a wire of the second material having the second resistivity such as a Chromel (NiCr) wire, where the NiCr wire has a higher resistivity than the NiAl wire, and the wires are of the same wire gage. As shown, the breakouts 30 and 34 include a wire of the first material and the breakouts 32 and 36 include a wire of the second material.

The third branch 16 has extending from it a plurality of thermocouple terminal breakouts for coupling to a respective thermocouple probe. For example, extending from the third branch 16 are one or more thermocouple terminal breakouts, and as shown, four thermocouple terminal breakouts 50, 52, 54, and 56 each having a wire end crimp terminal 58, 60, 62, 64 configured to couple to a thermocouple probe assembly, sometimes referred to as TC3. Two of the breakouts 50 and 52 are for the first circuit, and two of the breakouts 54 and 56 are for the second circuit. Each of the first and second circuits includes a wire of the first material having the first resistivity, such as a NiAl wire, and a wire of the second material having the second resistivity, such as a NiCr wire. As shown, the breakouts 50 and 54 include a wire of the first material and the breakouts 52 and 56 include a wire of the second material.

Similarly, extending from the third branch 16 are one or more thermocouple terminal breakouts, and as shown, four thermocouple terminal breakouts 70, 72, 74, and 76 each having a wire end crimp terminal 78, 80, 82, 84 configured to couple to a thermocouple probe assembly, sometimes referred to as TC4. The thermocouple terminal breakouts 50, 52, 54 and 56 are positioned closer to the thermocouple terminal breakouts 30, 32, 34 and 36 than the thermocouple terminal breakouts 70, 72, 74 and 76. Two of the breakouts 70 and 72 are for the first circuit, and two of the breakouts 74 and 76 are for the second circuit. Each of the first and second circuits includes a wire of the first material having the first resistivity, such as a NiAl wire, and a wire of the second material having the second resistivity, such as a NiCr wire. As shown, the breakouts 70 and 74 include a wire of the first material and the breakouts 72 and 76 include a wire of the second material.

Also extending from the third branch 16 are one or more thermocouple terminal breakouts, and as shown, four thermocouple terminal breakouts 90, 92, 94, and 96 each having a wire end crimp terminal 98, 100, 102, 104 configured to couple to a thermocouple probe assembly, sometimes referred to as TC1. The thermocouple terminal breakouts 90, 92, 94, and 96 are positioned at or near an end of the third branch 16 and the thermocouple terminal breakouts 70, 72, 74 and 76 are positioned between the thermocouple terminal breakouts 90, 92, 94, and 96 and the thermocouple terminal breakouts 50, 52, 54 and 56. Two of the breakouts 90 and 92 are for the first circuit, and two of the breakouts 94 and 96 are for the second circuit. Each of the first and second circuits includes a wire of the first material having the first resistivity, such as a NiAl wire, and a wire of the second material having the second resistivity, such as a NiCr wire. As shown, the breakouts 90 and 94 include a wire of the first material and the breakouts 92 and 96 include a wire of the second material.

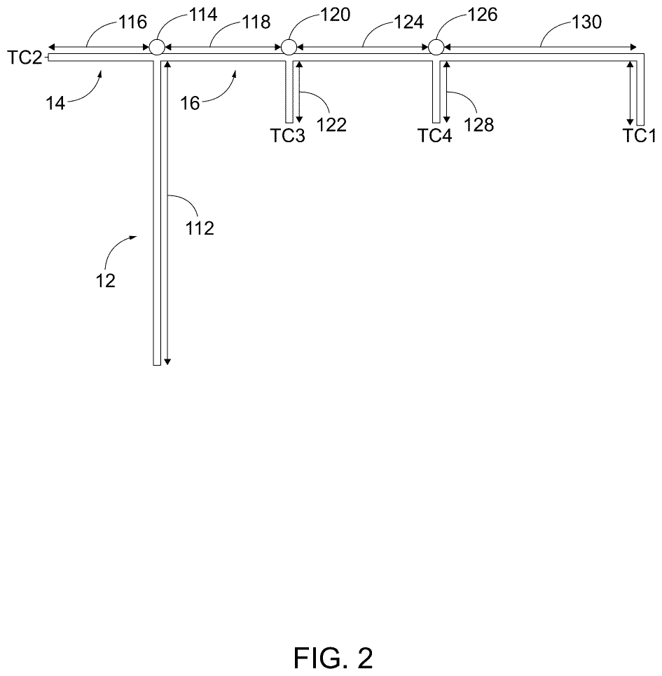

Turning now to FIG. 2, a schematic wire diagram 110 illustrating the arrangement of wires of the first material having the first resistivity, such as NiAl wire, for one of the circuits along with the first, second, and third branches 12-16 is shown. The arrangement of wires of the first material having the first resistivity includes a first wire or trunk line 112 in the first branch 12 that connects to a first splice 114, for example where the first branch 12 meets with the second and third branches 14 and 16. Connected to the first splice 114 is a second wire 116 that connects to TC2 and a third wire 118 that connects to a second splice 120. Connected to the second splice 120 is a fourth wire 122 that connects to TC3 and a fifth wire 124 that connects to a third splice 126. Connected to the third splice 126 is a sixth wire 128 that connects to TC4 and a seventh wire 130 that connects to TC1. By joining the wires 112, 116, 118, 122, 124, 128, and 130 at the splices 114, 120, and 126, a minimal amount of wire is utilized in the system to maintain a balanced series resistance between thermocouples while reducing the amount and therefore weight of wire used.

For both the first and second circuits, the first wire 112 has a length greater than the seventh wire 130, which has a length greater than the fifth wire 124, which has a length greater than the third wire 118, which has a length greater than the second, fourth, and sixth wires 116, 122, and 128. In the first circuit, the sixth wire 128 has a length greater than the length of the second and fourth wires 116 and 122, which are the same or substantially the same as one another. In the second circuit, the fourth wire 122 has a length greater than the second wire 116, which has a length greater than the sixth wire 128.

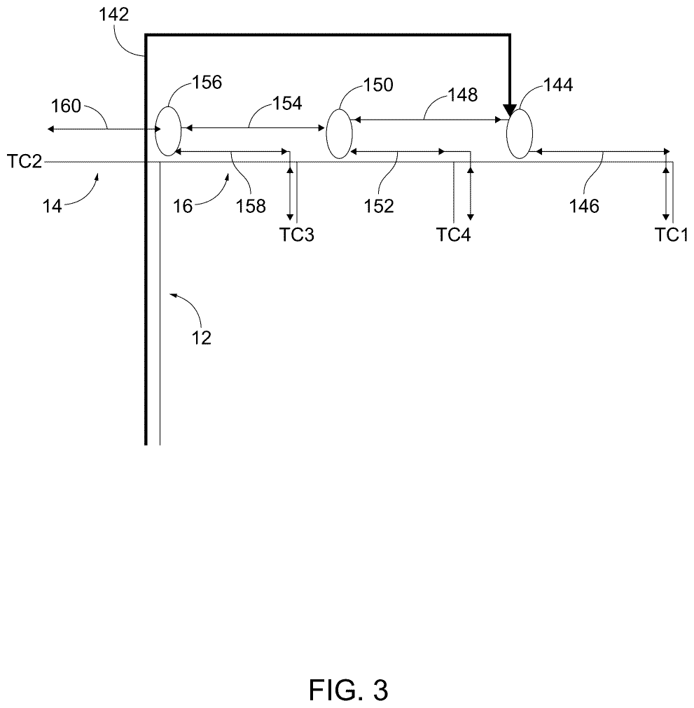

Turning now to FIG. 3, a schematic wire diagram 140 illustrating the arrangement of wires of the second material having the second resistivity, such as NiCr wire, for one of the circuits along with the first, second, and third branches 12-16 is shown. The arrangement of wires of the second material having the second resistivity includes a first wire or trunk line 142 in the first and third branches 12 and 16 that connects to a first splice 144, for example between TC1 and TC4. Connected to the first splice 144 is a second wire 146 that connects to TC1 and a third wire 148 that connects to a second splice 150. Connected to the second splice 150 is a fourth wire 152 that connects to TC4 and a fifth wire 154 that connects to a third splice 156. Connected to the third splice 156 is a sixth wire 158 that connects to TC3 and a seventh wire 160 that connects to TC2. By joining the wires 146, 148, 152, 154, 158, and 160 at the splices 144, 150, and 156, a minimal amount of wire is utilized in the system to maintain a balanced series resistance between thermocouples while reducing the amount and therefore weight of wire used.

For the first circuit, the first wire 142 has a length greater than the second wire 146, which has a length greater than the third wire 148, which has a length greater than the fourth wire 152, which has a length greater than the seventh wire 160, which has a length greater than the sixth wire 158, which has a length greater than the fifth wire 154. For the second circuit, the first wire 142 has a length greater than the third wire 148, which has a length greater than the second wire 146, which has a length greater than the fourth wire 152, which has a length greater than the seventh wire 160, which has a length greater than the sixth wire 158, which has a length greater than the fifth wire 154. The first wire 142 is longer than the first wire 112. By using more higher resistance wire than lower resistance wire, for example using more NiCr wire than NiAl wire, the total amount of wire in the harness may be reduced, thereby reducing the weight.

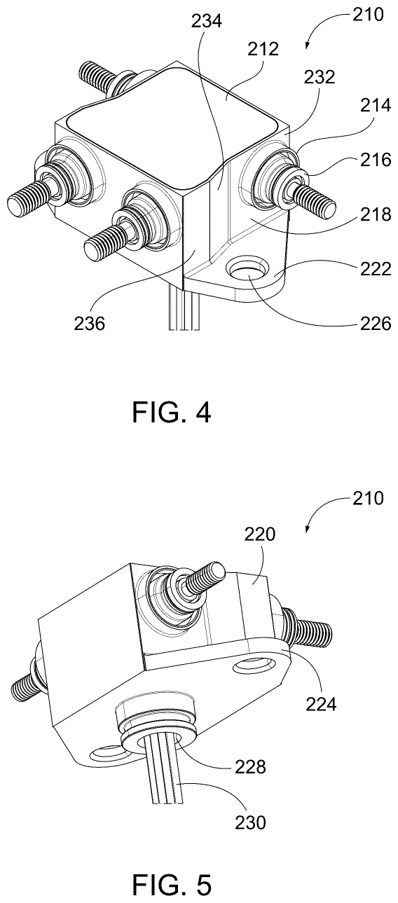

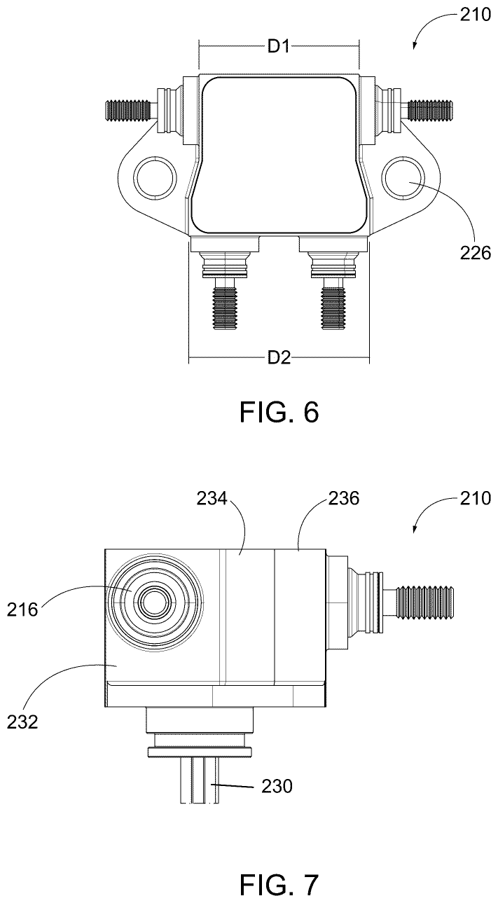

Turning now to FIGS. 4-13, an exemplary thermocouple probe assembly is shown at reference numeral 210, such as an exhaust gas temperature probe assembly. The assembly 210 includes a body 212 having a plurality of openings 214, such as four openings through which respective studs 216 extend for connecting to one of the wire end crimp terminals. The studs 216 may be hermetically sealed and welded to the openings 214 to prevent loosening due to vibration. Extending from sides 218 and 220 of the body 212 are wings 222 and 224 that each have an opening 226 for receiving a respective fastener to couple the assembly 210 to an engine. Extending from the bottom of the housing is an opening 228 through which wires 230 extend that are connected to thermocouples.

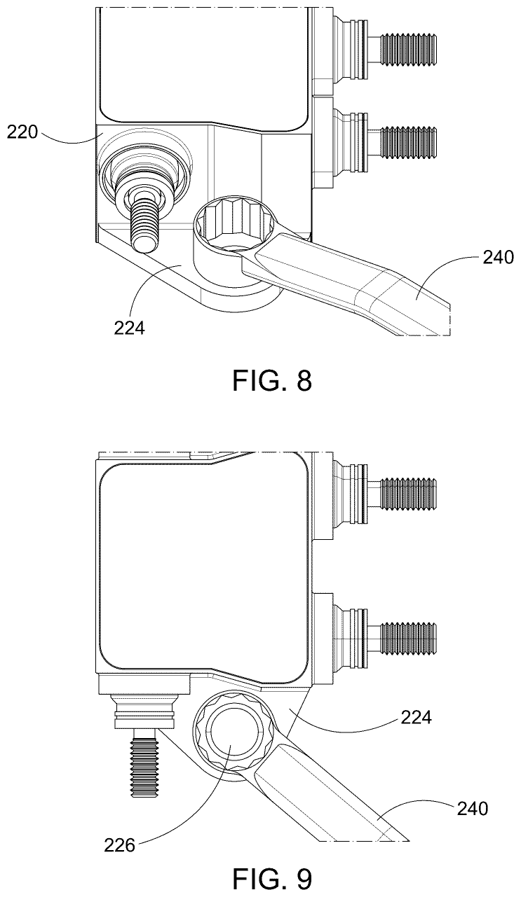

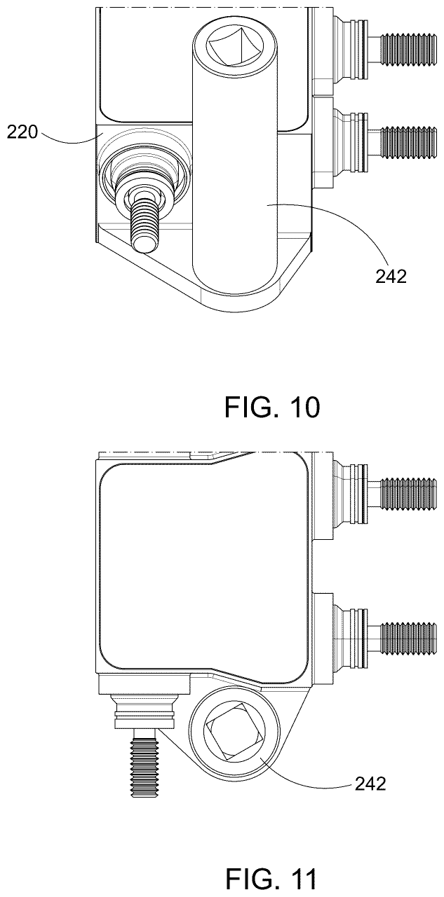

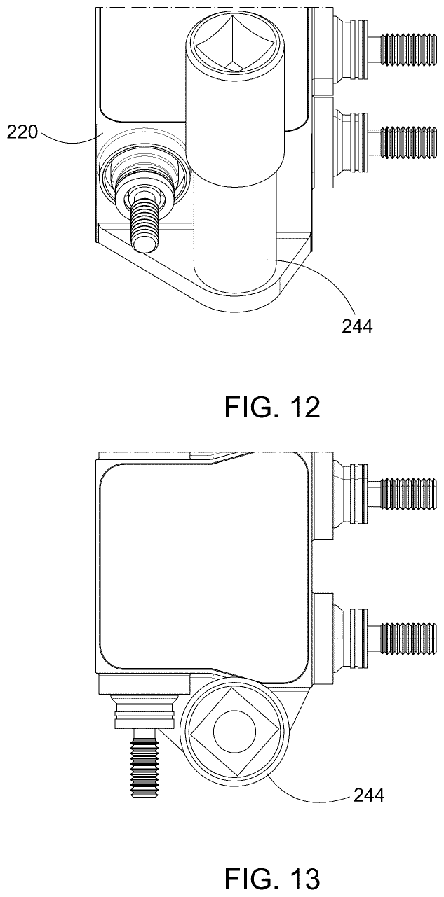

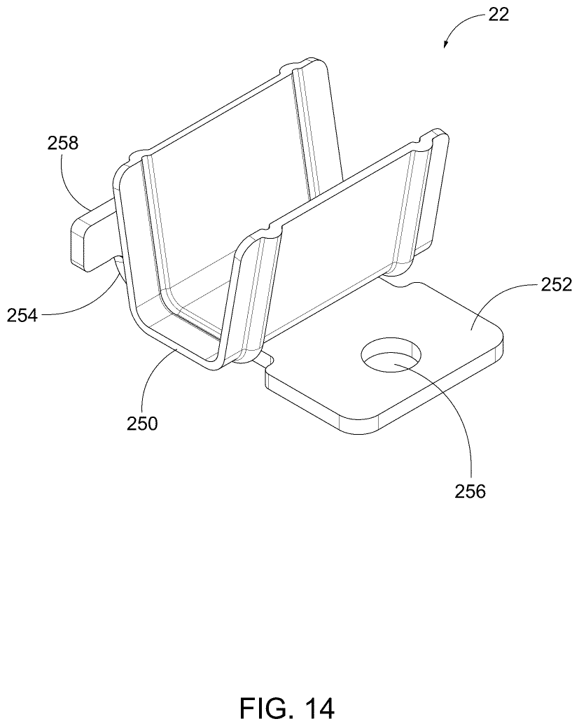

Each side 218, 220 of the body 212 has a first portion 232 through which a respective one of the openings 214 extends and which are spaced a first distance D1 from one another. Each side 218, 220 also includes a second portion 234 angled outward from the respective first portion 232, and a third portion 236 substantially parallel to the first portion 232 and spaced a second distance D2 from the third portion 236 on the other side. The second distance D2 is greater than the first distance D1. The sides 218 and 220 are thereby jogged near the openings 226 creating space for a tool, such as a wrench or socket, between the studs 216 and the sides 218 and 220 to tighten the fasteners received in the openings 226. FIGS. 8 and 9 illustrate a wrench 240 positioned over opening 226 showing the clearance between the wrench 240, the side 220, and the stud 216, FIGS. 10 and 11 illustrate a first socket 242 positioned over opening 226 showing the clearance between the first socket 242, the side 220, and the stud 216, and FIGS. 12 and 13 illustrate a second socket 244 positioned over opening 226 showing the clearance between the second socket 244, the side 220, and the stud 216.

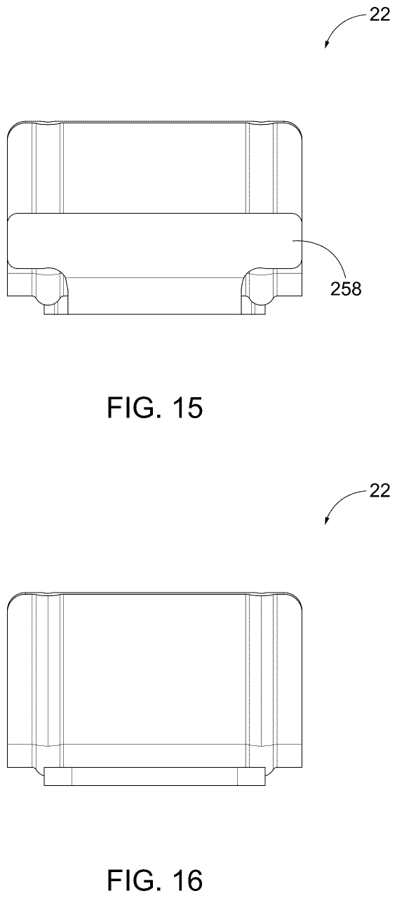

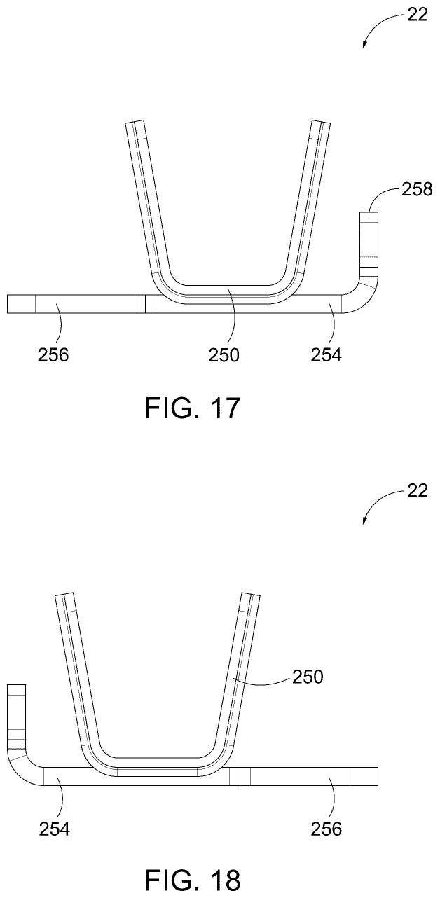

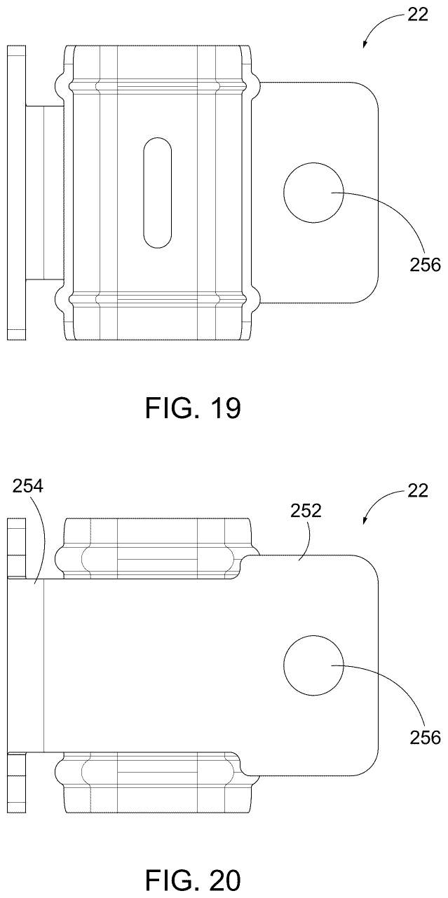

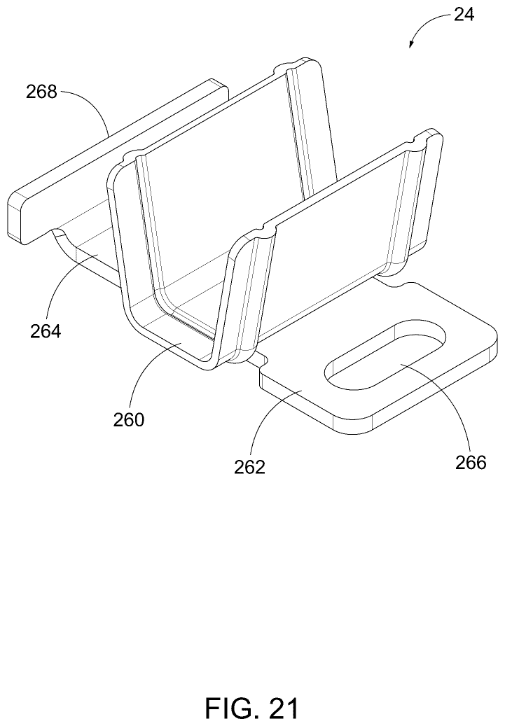

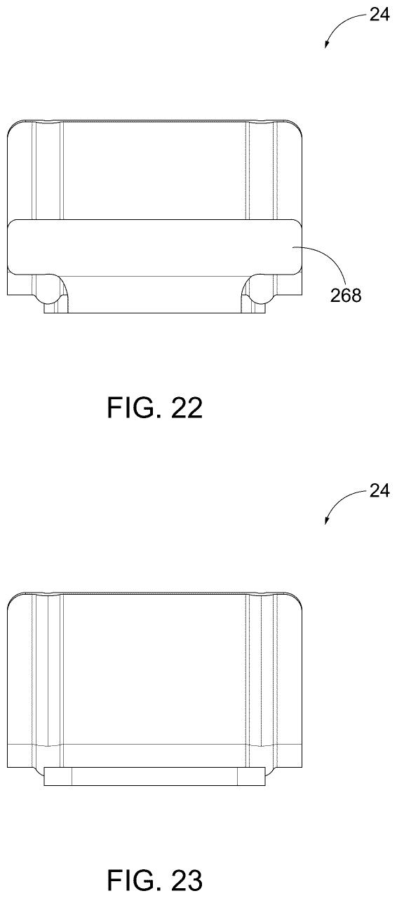

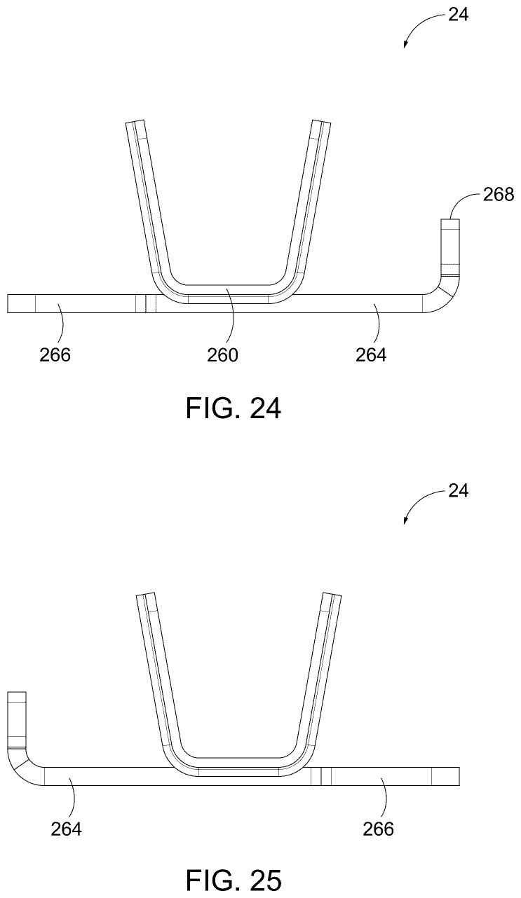

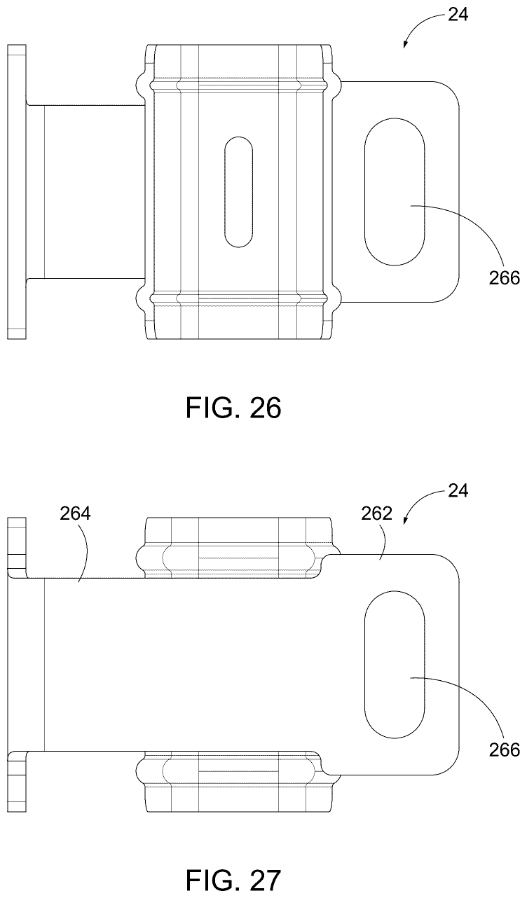

Turning now to FIGS. 14-27, the anti-rotation clips 22 and 24 will be described in detail. The anti-rotation clips 22 and 24 are configured to couple to a U-shaped watershield that is coupled to the engine. The anti-rotation clip 22 couples to the watershield near a first end of the watershield, and the anti-rotation clip 24 couples to the watershield near a second end of the watershield.

The anti-rotation clip 22 includes a body having a first leg 252 including an opening 256 for receiving a fastener to couple the anti-rotation clip 22 to the watershield, and a second leg 254 including a tab 258 extending from its end for contacting a top of the watershield. As the fastener received in the opening 256 is tightened, the tab 258 will shift clockwise until it contacts the top of the watershield to prevent full rotation and control an angle of movement within the anti-rotation clip 22. Coupled to the body, for example by welding or formed therewith, is a substantially U-shaped body 250 that is deformed around the first branch 12 of the harness to hold the harness in position. The first leg 252 extends to one side of the U-shaped body 250 and the second leg 254 extends to the other side of the body.

Similarly, the anti-rotation clip 24 includes a body having a first leg 262 including an opening 266 for receiving a fastener to couple the anti-rotation clip 24 to the watershield, and a second leg 264, which is longer than the second leg 254 on the anti-rotation clip 22, including a tab 268 extending from its end for contacting a top of the watershield. As the fastener received in the opening 266 is tightened, the tab 268 will shift clockwise until it contacts the top of the watershield to prevent full rotation and control an angle of movement within the anti-rotation clip 24. Coupled to the body, for example by welding or formed therewith, is a substantially U-shaped body 260 that is deformed around the first branch 12 of the harness to hold the harness in position. The first leg 262 extends to one side of the U-shaped body 260 and the second leg 264 extends to the other side of the body.

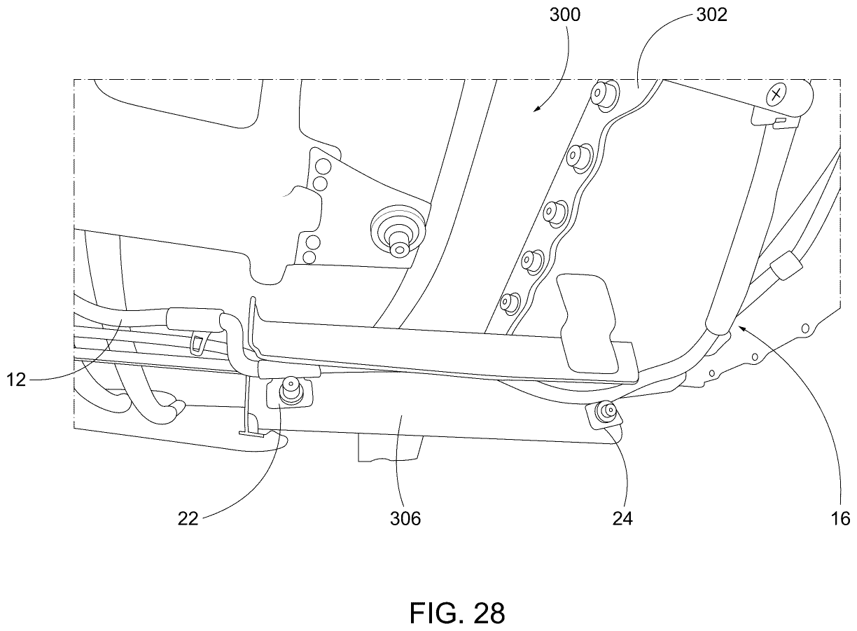

Turning now to FIGS. 28-33, an engine 300 is shown with the wire harness 10 installed. The wire harness 10 is routed to increase connections to a P-flange 302 of the engine for increased clearance and to minimize connections near an end of the engine 300 at a T-flange 304 to reduce chafing and to minimize where the wire harness 10 crosses oil tubes.

As shown in FIG. 28, the wire harness 10 is routed such that the first branch 12 is coupled to the engine 300 with the first branch 12 being coupled to the watershield 306 via the anti-rotation clips 22 and 24 at the end of the branch 12 near the intersection with the second and third branches 14 and 16. During installation, the first branch 12 is formed with two ninety-degree bends outside the watershield 306 near the anti-rotation clip 22.

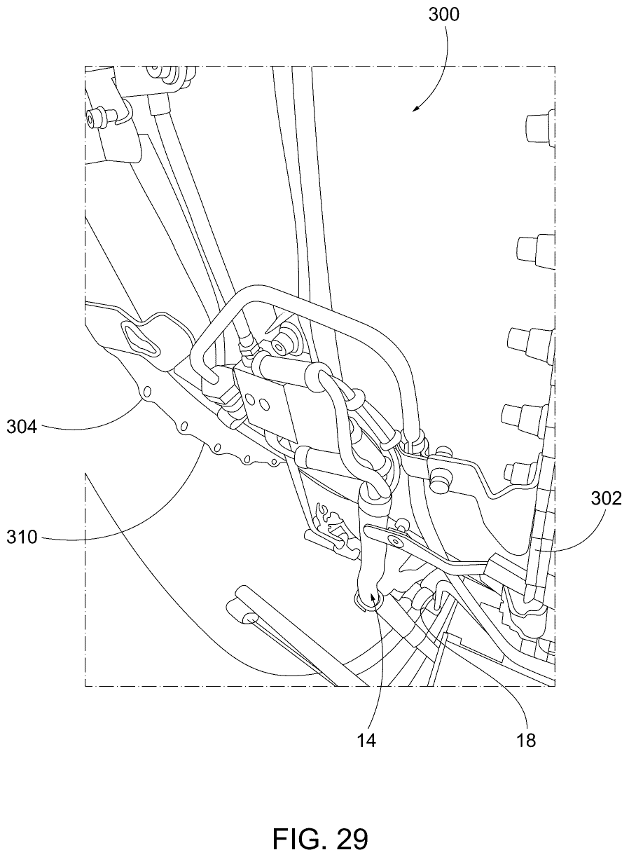

As shown in FIG. 29, the second branch 14 extends around the engine 300 and is coupled to the P-flange 302 via one or more clips 18. The wire end crimp terminals 38, 40, 42, and 44 of the thermocouple terminal breakouts 30, 32, 34 and 36 are coupled to a thermocouple probe assembly 310, TC2, with the second branch 14 being between the thermocouple probe assembly 310 and the P-flange 302.

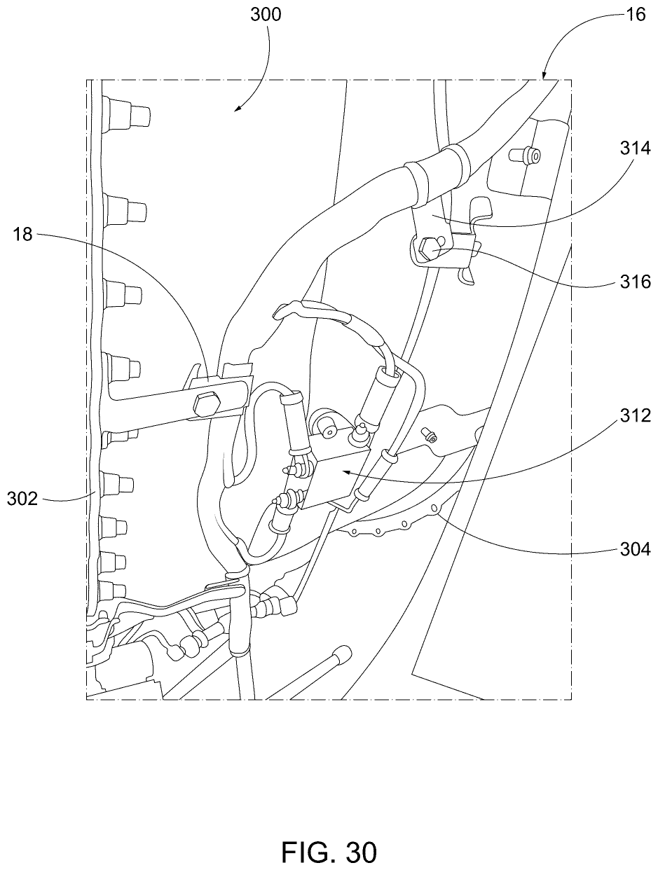

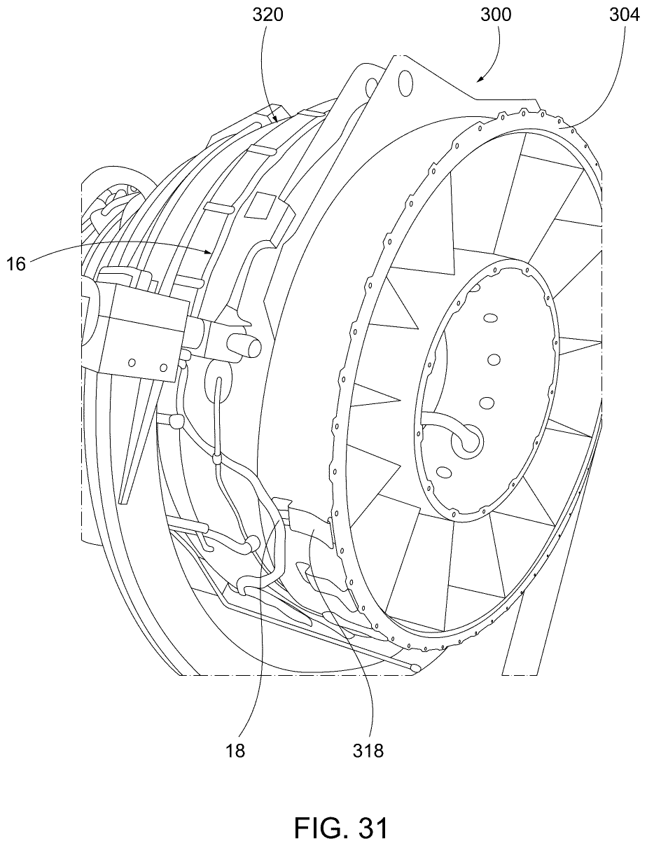

As shown in FIG. 30, the third branch 16 extends around the engine 300 and is coupled to the P-flange 302 via one or more clips 18. The wire end crimp terminals 58, 60, 62, and 64 of the thermocouple terminal breakouts 50, 52, 54 and 56 are coupled to a thermocouple probe assembly 312, TC3, with the third branch 16 being between the thermocouple probe assembly 312 and the P-flange 302. An extended clip 314 is coupled to an existing fastener 316 on the engine 300 and the wire harness 10 routed toward the T-flange 304.

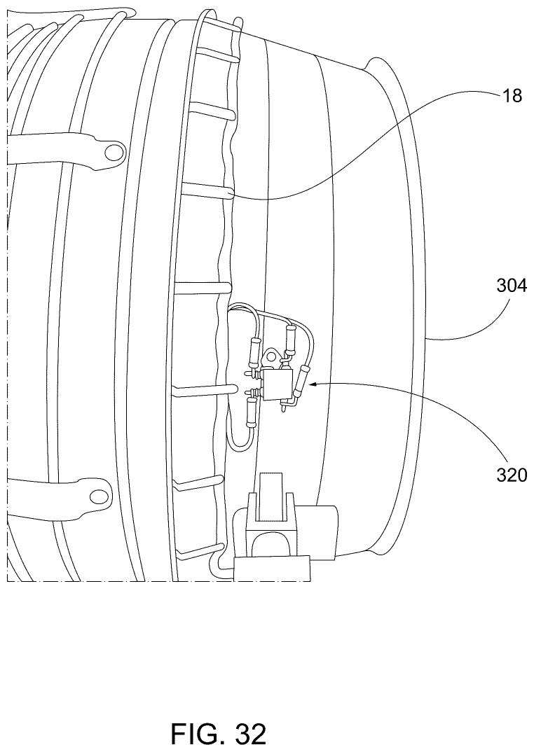

As shown in FIG. 31, the third branch 16 of the wire harness 10 is coupled to a bracket 318 coupled to the T-flange 304 by a clip 18 and the wire harness 10 routed back toward the P-flange 302. By providing for only a single connection to the T-flange 304, interference with the nacelle is reduced. As shown in FIG. 32, the third branch 16 is further coupled to the P-flange 302 via a plurality of clips 18. The wire end crimp terminals 78, 80, 82, and 84 of the thermocouple terminal breakouts 70, 72, 74 and 76 are coupled to a thermocouple probe assembly 320, TC4, with the third branch 16 being between the thermocouple probe assembly 320 and the P-flange 302.

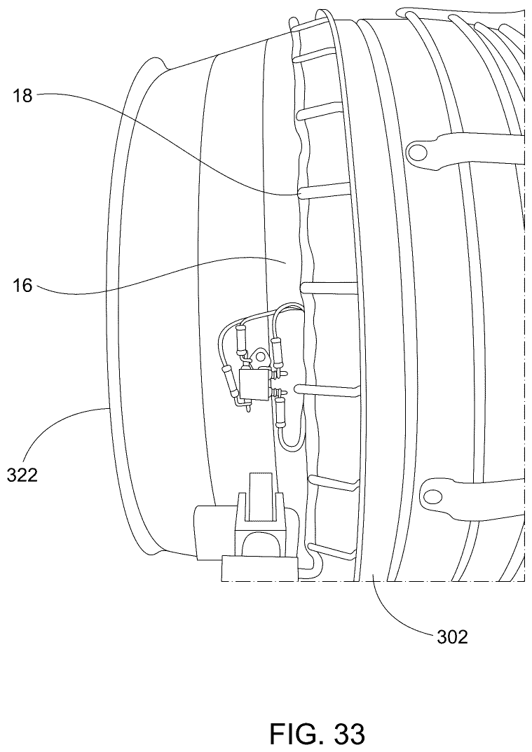

As shown in FIG. 33, the third branch 16 of the wire harness is further coupled to the P-flange 302 via a plurality of clips 18. The wire end crimp terminals 98, 100, 102, and 104 of the thermocouple terminal breakouts 90, 92, 94 and 96 are coupled to a thermocouple probe assembly 322, TC1, with the third branch 16 being between the thermocouple probe assembly 322 and the P-flange 302.

Although certain embodiments have been shown and described, it is understood that equivalents and modifications falling within the scope of the appended claims will occur to others who are skilled in the art upon the reading and understanding of this specification.

What is claimed is:

1. A thermocouple wire harness comprising:
a first branch;
a second branch extending about ninety degrees from the first branch in a first direction and having a first pair of thermocouple terminal breakouts extending therefrom for coupling to a first thermocouple; and
a third branch extending about ninety degrees from the first branch in a second direction opposite the first direction, the third branch having a second pair of thermocouple terminal breakouts extending therefrom for coupling to a second thermocouple, a third pair of thermocouple terminal breakouts extending therefrom for coupling to a third thermocouple, and a fourth pair of thermocouple terminal breakouts extending therefrom for coupling to a fourth thermocouple.

2. The thermocouple wire harness according to claim 1, wherein the third pair of thermocouple terminal breakouts is closer to the second pair of thermocouple terminal breakouts than to the fourth pair of thermocouple terminal breakouts.

3. The thermocouple wire harness according to claim 1, further comprising an anti-rotation clip for coupling the first branch to a watershield of an engine, wherein the anti-rotation clip includes a tab configured to contact a surface of the watershield to prevent full rotation of the thermocouple wire harness.

4. The thermocouple wire harness according to claim 3, wherein the anti-rotation clip includes a first leg including an opening for coupling to the watershield, and a second leg including the tab.

5. The thermocouple wire harness according to claim 3, further comprising another anti-rotation clip for coupling the first branch to the watershield, wherein the another anti-rotation clip includes a tab configured to contact the surface of the watershield to prevent full rotation of the thermocouple wire harness.

6. The thermocouple wire harness according to claim 5, wherein the another anti-rotation clip includes a first leg including an opening for coupling to the watershield, and a second leg including the tab.

7. The thermocouple wire harness according to claim 6, wherein the second leg on the another anti-rotation clip is longer than the second leg on the anti-rotation clip.

8. The thermocouple wire harness according to claim 1, wherein one of the wires in each pair is of a first material having a first resistivity and one of the wires in each pair is of a second material having a second resistivity different than the first resistivity.

9. The thermocouple wire harness according to claim 1, wherein the second branch includes a fifth pair of thermocouple terminal breakouts extending therefrom for coupling to a fifth thermocouple, and wherein the third branch has a sixth pair of thermocouple terminal breakouts extending therefrom for coupling to a sixth thermocouple, a seventh pair of thermocouple terminal breakouts extending therefrom for coupling to a seventh thermocouple, and an eighth pair of thermocouple terminal breakouts extending therefrom for coupling to an eighth thermocouple.

10. The thermocouple wire harness according to claim 1, wherein the third branch is at least six times longer than the second branch.

11. A thermocouple wire harness comprising:
a plurality of wires of a first material having a first resistivity, each of the plurality of wires being coupled to at least one of a first plurality of wire splices, and at least two of the wires being coupled to a respective thermocouple; and
a plurality of wires of a second material having a second resistivity different than the first resistivity, each of the plurality of wires of the second material being coupled to at least one of a second plurality of wire splices, and at least two of the wires being coupled to a respective one of the thermocouples.

12. The thermocouple wire harness according to claim 11, wherein one of the plurality of wires of the first material extends from a connector to one of the first plurality of wire splices and is a first length, and one of the plurality of wires of the second material extends from the connector to one of the second plurality of wire splices and is a second length greater than the first length.

13. The thermocouple wire harness according to claim 12, wherein the second length is at least one and a half times greater than the first length.

14. The thermocouple wire harness according to claim 11, wherein a total wire length of the plurality of wires of the second material is greater than a total wire length of the plurality of wires of the first material.

15. A thermocouple wire harness comprising:
a first wire of a first material having a first resistivity coupled to a first wire splice;
a second wire of the first material coupled to the first wire splice and a first thermocouple;
a third wire coupled to the first wire splice and a second wire splice;
a fourth wire coupled to the second wire splice and a second thermocouple;
a fifth wire coupled to the second wire splice and a third wire splice;
a sixth wire coupled to the third wire splice and a third thermocouple; and
a seventh wire coupled to the third wire splice and a fourth thermocouple.

16. The thermocouple wire harness according to claim 15, wherein the first wire has a length greater than the seventh wire, which has a length greater than the fifth wire, which has a length greater than the third wire, which has a length greater than the second, fourth, and sixth wires.

17. The thermocouple wire harness according to claim 15, further comprising:
a first wire of a second material having a second resistivity different than the first material coupled to a first wire splice;
a second wire of the second material coupled to the first wire spice and the fourth thermocouple;
a third wire of the second material coupled to the first wire spice and a second wire splice;
a fourth wire of the second material coupled to the second wire splice and the third thermocouple;
a fifth wire of the second material coupled to the second wire splice and a third wire splice;
a sixth wire of the second material coupled to the third wire splice and the second thermocouple; and
a seventh wire of the second material coupled to the third wire splice and the first thermocouple.

18. The thermocouple wire harness according to claim 17, wherein the first wire has a length greater than the second wire, which has a length greater than the third wire, which has a length greater than the fourth wire, which has a length greater than the seventh wire, which has a length greater than the sixth wire, which has a length greater than the fifth wire.

19. The thermocouple wire harness according to claim 17, wherein the first wire has a length greater than the third wire, which has a length greater than the second wire, which has a length greater than the fourth wire, which has a length greater than the seventh wire, which has a length greater than the sixth wire, which has a length greater than the fifth wire.

20. The thermocouple wire harness according to claim 17, wherein a total length of the first, second, third, fourth, fifth, sixth, and seventh wires of the second material is greater than a total length of the first, second, third, fourth, fifth, sixth, and seventh wires of the first material.
